(19) United States
(12) Patent Application Publication
(10) Pub. No.: US 2025/0097809 A1
(43) Pub. Date: Mar. 20, 2025

(54) COVERAGE-AWARE JOINT CONFIGURATION FOR MULTI-NETWORK WIRELESS COMMUNICATION

(71) Applicant: QUALCOMM Incorporated, San Diego, CA (US)

(72) Inventors: Anantharaman BALASUBRAMANIAN, San Diego, CA (US); Shuanshuan WU, San Diego, CA (US); Dan VASSILOVSKI, Del Mar, CA (US); Liangping MA, San Diego, CA (US); Kapil GULATI, Belle Mead, NJ (US)

(21) Appl. No.: 18/468,141

(22) Filed: Sep. 15, 2023

(51) Int. Cl. H04W 36/32; H04W 36/00

(52) U.S. Cl. CPC H04W 36/322; H04W 36/0069

(57) ABSTRACT

Techniques are disclosed for coverage-aware joint configuration for multi-network wireless communication. The techniques can include identifying a travel route for travel of a user equipment (UE) from a start location to a destination location, obtaining multi-network wireless coverage information for the travel route, wherein the multi-network wireless coverage information includes terrestrial network (TN) wireless coverage information and non-terrestrial network (NTN) wireless coverage information, determining a joint TN/NTN wireless communication configuration for the UE for the travel route based on the multi-network wireless coverage information, and sending the joint TN/NTN wireless communication configuration to the UE.

### BACKGROUND

### 1. Field of Disclosure

The present disclosure relates generally to the field of wireless communications, and more specifically to wireless communications of mobile wireless communication devices in terrestrial and non-terrestrial wireless communication networks.

### 2. Description of Related Art

A user equipment (UE) traveling in a terrestrial wireless communication network such as a terrestrial radio access network (RAN) can be provided with wireless data connectivity by various cells of the terrestrial wireless communication network as it moves within or through those cells. Using such wireless data connectivity, the UE may be able to communicate with one or more packet data network (PDNs), such as the Internet. If the UE possesses appropriate capabilities, it may also be able to obtain wireless data connectivity from a non-terrestrial wireless communication network, such as a satellite-based wireless communication (SBWC) network. If so, when the UE is within both coverage of a terrestrial wireless communication network cell and coverage of the non-terrestrial wireless communication network, it may be possible for the UE to conduct wireless data communications using either type of wireless data connectivity. It may also be possible for the UE to establish and use terrestrial network (TN)-based and non-terrestrial network (NTN)-based wireless data connectivity in parallel by operating in a dual-connectivity mode.

### BRIEF SUMMARY

An example method for configuring multi-network wireless communication of a user equipment (UE), according to this disclosure, may include identifying a travel route for travel of the UE from a start location to a destination location, obtaining multi-network wireless coverage information for the travel route, wherein the multi-network wireless coverage information includes terrestrial network (TN) wireless coverage information and non-terrestrial network (NTN) wireless coverage information, determining a joint TN/NTN wireless communication configuration for the UE for the travel route based on the multi-network wireless coverage information, and sending the joint TN/NTN wireless communication configuration to the UE.

An example apparatus for configuring multi-network wireless communication of a UE, according to this disclosure, may include at least one memory, at least one transceiver, and at least one processor coupled to the at least one memory and the at least one transceiver, the at least one processor configured to identify a travel route for travel of the UE from a start location to a destination location, obtain multi-network wireless coverage information for the travel route, wherein the multi-network wireless coverage information includes terrestrial network TN wireless coverage information and non-terrestrial network NTN wireless coverage information, determine a joint TN/NTN wireless communication configuration for the UE for the travel route based on the multi-network wireless coverage information, and send, via the at least one transceiver, the joint TN/NTN wireless communication configuration to the UE.

Another example method for configuring multi-network wireless communication of a UE, according to this disclosure, may include sending position and destination information from the UE to a network node, the position and destination information indicating a start location of the UE and a destination location of the UE, receiving, from the network node, configuration information indicating a joint TN/NTN wireless communication configuration for the UE for a travel route from the start location to the destination location, and applying the joint TN/NTN wireless communication configuration at the UE during travel of the UE from the start location to the destination location via the travel route.

Another example apparatus for configuring multi-network wireless communication of a UE, according to this disclosure, may include at least one memory, at least one transceiver, and at least one processor coupled to the at least one memory and the at least one transceiver, the at least one processor configured to send, via the at least one transceiver, position and destination information from the UE to a network node, the position and destination information indicating a start location of the UE and a destination location of the UE, receive, from the network node, via the at least one transceiver, configuration information indicating a joint TN/NTN wireless communication configuration for the UE for a travel route from the start location to the destination location, and apply the joint TN/NTN wireless communication configuration at the UE during travel of the UE from the start location to the destination location via the travel route.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of an example wireless coverage scenario.

FIG. 3 is a block diagram illustrating an example operating environment, according to aspects of the disclosure.

FIG. 4 is a block diagram showing a first example method for coverage-aware joint configuration for multi-network wireless communication, according to an embodiment.

FIG. 5 is a block diagram showing a second example method for coverage-aware joint configuration for multi-network wireless communication, according to an embodiment.

FIG. 6 is a block diagram of an embodiment of a UE, which can be utilized in embodiments as described herein.

FIG. 7 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects generally relate to wireless communications, and more particularly to wireless communications of mobile wireless communication devices in terrestrial and non-terrestrial wireless communication networks. Some aspects more specifically relate to techniques for coverage-aware joint configuration of mobile wireless communication devices for multi-network wireless communications. According to some aspects, a network node of a terrestrial wireless communication network such as a terrestrial radio access network (RAN) can provide a joint terrestrial network (TN)/non-terrestrial network (NTN) wireless communication configuration to mobile wireless communication device, such as a user equipment (UE), operating in the terrestrial wireless communication network.

The joint TN/NTN wireless communication configuration can configure multi-network wireless communications of the mobile wireless communication device in conjunction with travel of the mobile wireless communication device along a travel route from a start location to a destination location. The multi-network wireless communications can include wireless communications with the terrestrial wireless communication network and with a non-terrestrial wireless communication network. The joint TN/NTN wireless communication configuration can be determined based on multi-network wireless coverage information that indicates where, in the vicinity of the travel route, TN-based and NTN-based wireless coverage are or are not available. According to some aspects, the multi-network wireless coverage information can reflect time-based variance of the locations of NTN-based wireless coverage, and can be used to determine where, in the vicinity of the travel route, satisfactory NTN-based wireless coverage will be available based on the time of day of the travel of the mobile wireless communication device. According to some aspects, the multi-network wireless coverage information can be used to assess multiple candidate travel routes for the mobile wireless communication device, and the travel route can be selected from among the multiple candidate travel routes based on the availability of satisfactory TN-based and NTN-based wireless coverage, as indicated by the multi-network wireless coverage information.

The joint TN/NTN wireless communication configuration can generally specify whether, where, and how the mobile wireless communication device is to use a terrestrial wireless communication network and a non-terrestrial wireless communication network for wireless data communications as it travels along the travel route. According to some aspects, the joint TN/NTN wireless communication configuration can be crafted to provide the mobile wireless communication device with an acceptable quality of experience (QoE) by accounting for diminished or absent NTN-based coverage, TN-based coverage, or both in one or more regions along the travel route. In some examples, the joint TN/NTN wireless communication configuration can indicate a region along the travel route in which the mobile wireless communication device is to refrain from using the non-terrestrial network, or is to use an alternate non-terrestrial network. In some examples, the joint TN/NTN wireless communication configuration can indicate a region along the travel route in which the mobile wireless communication device is to operate in a dual-connectivity mode, and use TN-based and NTN-based wireless data connectivity in parallel.

According to aspects of the disclosure, jointly configuring the TN-based and NTN-based wireless data communications of the mobile wireless communication device can enable the TN-based and NTN-based wireless communication capabilities of the mobile wireless communication device to be used to supplement each other in an efficient manner. For instance, rather than maintaining an “always on” state for NTN communications, the mobile wireless communication device can activate its NTN-based communication capabilities when appropriate (such as when TN-based coverage is diminished or absent, or when operation in the dual-connectivity mode is desirable), while otherwise deactivating its NTN-based communication capabilities to conserve power and reduce NTN overhead. According to some aspects, considering the timing of the travel of the mobile wireless communication device in conjunction with determining the joint TN/NTN wireless communication configuration so as to account for time-based variance of the locations of NTN-based wireless coverage can increase the effectiveness of the joint configuration. According to some aspects, configuring the mobile wireless communication device for dual connectivity in a coverage-aware manner according to the techniques disclosed herein can enable the mobile wireless communication device to maintain a satisfactory QoE as it travels along the travel route, despite diminished or absent TN-based or NTN-based wireless data coverage in regions along the travel route.

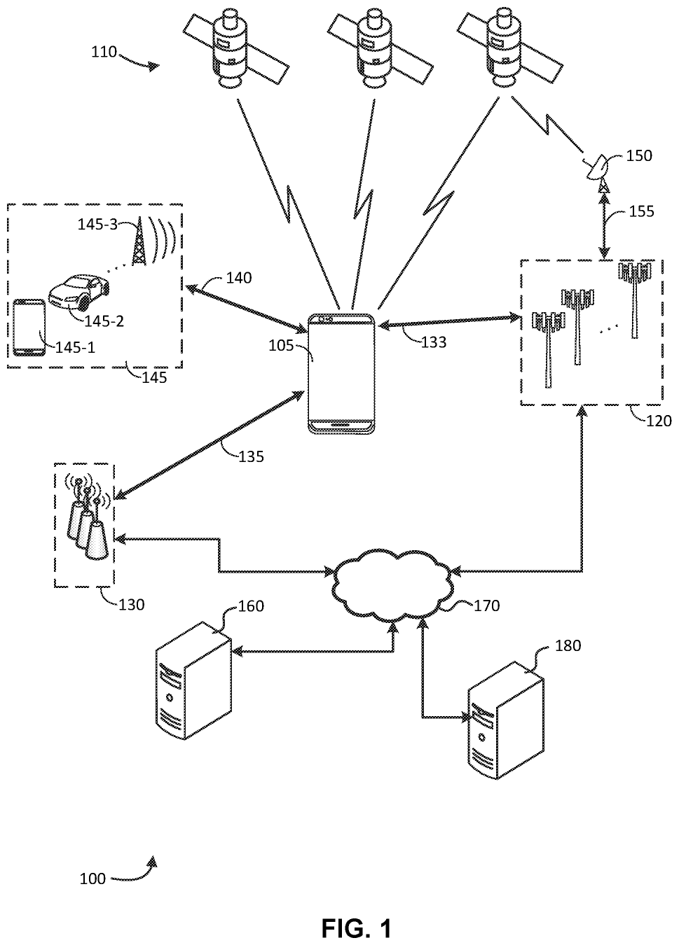

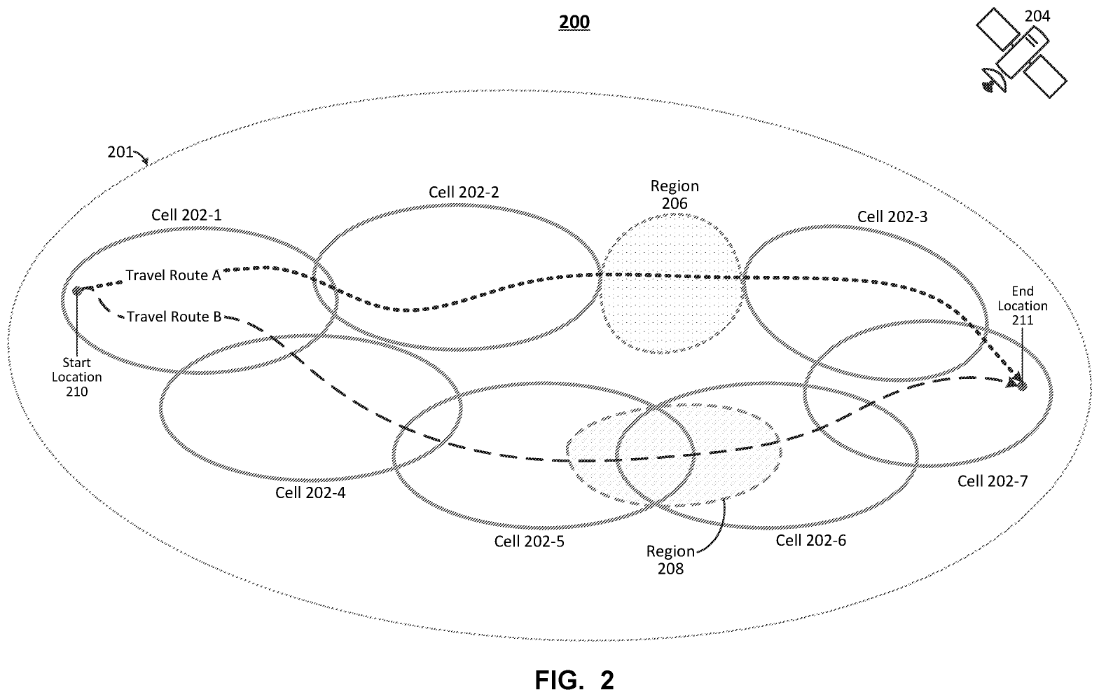

FIG. 1 is a simplified illustration of a positioning system 100 in which a UE 105, location server 160, and/or other components of the positioning system 100 can use the techniques provided herein for coverage-aware joint configuration for multi-network wireless communication, according to an embodiment. The techniques described herein may be implemented by one or more components of the positioning system 100, however the techniques described herein are not limited to such components and may be implemented in other types of systems (not shown). The positioning system 100 can include: a UE 105; one or more satellites 110 (also referred to as space vehicles (SVs)) for a Global Navigation Satellite System (GNSS) (such as the Global Positioning System (GPS), GLONASS, Galileo, or Beidou) and/or NTN functionality; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the UE 105 to communicate with the network 170 via satellites 110, but this can also enable network-based positioning, RF sensing, etc.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards.

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

FIG. 2 is a diagram of an example wireless coverage scenario 200, according to aspects of the disclosure. According to wireless coverage scenario 200, terrestrial network (TN) wireless coverage is available in a plurality of cells 202-1, 202-2, 202-3, 202-4, 202-5, 202-6, and 202-7 in a geographical area 201. According to aspects of the disclosure, cells 202-1 to 202-7 can be cells of a terrestrial radio access network (RAN). In some examples, for instance, cells 202-1 to 202-7 can be cells of a 3GPP RAN, such as an Evolved Universal Mobile Telecommunications System Terrestrial Radio Access Network (E-UTRAN) or a Next Generation Radio Access Network (NG-RAN). Such a RAN may provide capable devices in cells 202-1 to 202-7 with RAN-based data connectivity, which may enable such devices to access one or more packet data networks (PDNs), such as the Internet. Non-terrestrial network (NTN) wireless coverage is generally available in the geographical area 201 via satellite(s) 204. According to aspects of the disclosure, wireless coverage provided by satellite(s) 204 may furnish capable devices with satellite-based wireless communication (SWBC) data connectivity, which may, like RAN-based data connectivity, enable such devices to access one or more PDNs, such as the Internet.

According to wireless coverage scenario 200, there may be some positions within the geographical area 201 at which TN coverage, NTN coverage, or both are diminished or unavailable. In the example depicted in FIG. 2. TN wireless coverage may be diminished or unavailable in the region 206 between cells 202-2 and 202-3, and NTN wireless coverage may be diminished or unavailable in the region 208 that straddles cells 202-5 and 202-6.

If the quality or availability of TN/NTN wireless coverage varies from location to location in the geographical area 201, then a mobile wireless communication device traveling through the geographical area 201 may encounter varying coverage conditions over the course of its travel. Further, the particular coverage conditions that such a mobile wireless communication device encounters may depend on the route that it takes through the geographical area 201. For instance, a mobile wireless communication device (not shown in FIG. 2) that travels from a start location 210 to an end location 211 in the geographical area 201 may encounter different coverage conditions if it travels from the start location 210 to the end location 211 via a travel route A than it may if it travels from the start location 210 to the end location 211 via a travel route B. If the mobile wireless communication device traverses the travel route A, it may find NTN coverage (via satellite(s) 204) available throughout its journey, but may encounter diminished or unavailable TN coverage in the region 206. If the mobile wireless communication device traverses the travel route B, it may remain within TN coverage for the duration of its travel, but may encounter diminished or unavailable NTN coverage in the region 208.

Whether, where, and how a mobile wireless communication device can best use TN-based wireless data coverage and NTN-based wireless data coverage as it travels from start location 210 to end location 211 may depend on whether the mobile wireless communication device encounters any regions of absent or degraded TN or NTN coverage over the course of that travel, which in turn may depend on which travel route the mobile wireless communication device follows to get from start location 210 to end location 211. However, such a mobile wireless communication device may not have knowledge of some regions of absent or degraded TN or NTN coverage. For example, the coverage footprint of NTN coverage via satellite(s) 204 may vary over time due to orbital motion of satellite(s) 204 or other factors, such that NTN coverage is available in region 208 at some times, but is diminished or unavailable in region 208 at other times, and the mobile wireless communication device may be unaware of the times during which NTN coverage is available in region 208. As such, the mobile wireless communication device may not be able to autonomously determine how to best use TN-based wireless data coverage and NTN-based wireless data coverage over the course of travel via a given route, or to accurately select from among multiple possible travel routes to achieve a best quality of experience.

Disclosed herein are techniques for coverage-aware joint configuration for multi-network wireless communication. According to various such techniques, a network entity, such as a node in a terrestrial wireless communication network, can use knowledge of locations of absent or degraded TN or NTN coverage to determine how a mobile wireless communication device may best use TN-based wireless data coverage and NTN-based wireless data coverage over the course of travel via a given route. According to some such techniques, the network entity can use such knowledge to appropriately select a travel route for the mobile wireless communication device from among a set of candidate routes, such as to achieve a best quality of experience. In various examples, the locations of absent or degraded TN or NTN coverage may vary over time, and in view of this variance, the network entity may take the timing of the wireless mobile communication device's travel into account in conjunction with determining the appropriate TN and NTN usage for the wireless mobile communication device.

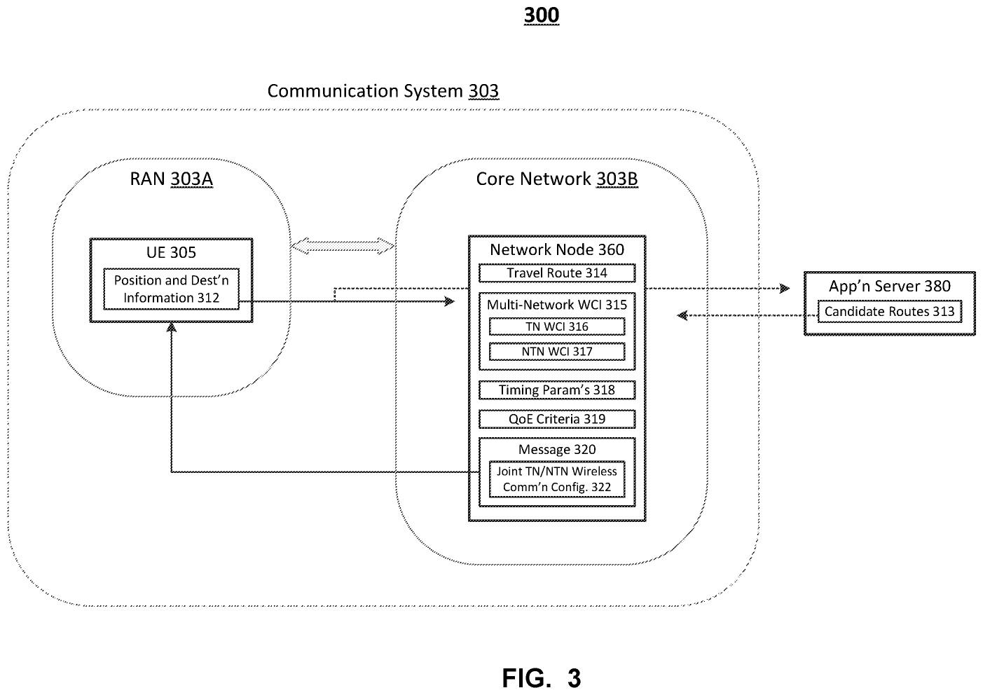

FIG. 3 is a block diagram illustrating an example operating environment 300 in which techniques for coverage-aware joint configuration for multi-network wireless communication may be implemented to configure TN-based and NTN-based wireless data communication of a UE 305 according to aspects of the disclosure. In operating environment 300, a communication system 303 includes a RAN 303A and a core network 303B. When the UE 305 is located within any of a plurality of cells of the RAN 303A, the RAN 303A can provide TN-based wireless data connectivity to the UE 305. According to some implementations, the RAN 303A can be a 3GPP 5G RAN, such as an NG-RAN. According to some other implementations, the RAN 303A can be a 3GPP 4G RAN, such as an E-UTRAN. According to still other implementations, the RAN 303A can be another type of 3GPP RAN, such as a 3GPP 6G RAN, or can be a non-3GPP RAN. According to some implementations, the core network 303B can be a 3GPP 5G Core Network (5GC). According to some other implementations, the core network 303B can be a 3GPP 4G core network, such as an Evolved Packet Core (EPC). According to still other implementations, the core network 303B can be another type of 3GPP core network, such as a 3GPP 6G core network, or can be a non-3GPP core network.

In operating environment 300, a network node 360 of core network 303B can identify a travel route 314 for travel of the UE 305 from a start location to a destination location (such as from start location 210 to destination location 211 in FIG. 2). In some examples, the network node 360 can obtain position and destination information 312 from the UE 305, and can identify the start location and destination location based on the position and destination information 312. In some examples, the UE 305 can provide the position and destination information 312 to the core network 303B via the RAN 303A, by transmitting a message to a RAN node (such as a New Radio Node B (gNB), Next Generation Evolved Node B (ng-eNB), or an Evolved Node B (eNB)) in a cell of the RAN 303A. In some examples, the position and destination information 312 can indicate a position that constitutes the start location for the travel of the UE 305. That position may be a current position of the UE 305 in some examples, and may differ from the current position of the UE 305 in other examples. In some examples, the position and destination information 312 can additionally or alternatively indicate a position that constitutes the end location for the travel of the UE 305. In some examples, the position and destination information 312 can indicate positions corresponding to the start and end locations for the travel of the UE 305 in the form of absolute or relative geodetic coordinates, civic locations such as street addresses, intersections, and place names, or in some other form.

According to aspects of the disclosure, the network node 360 can determine a joint TN/NTN wireless communication configuration 322 for the UE 305 for the travel route 314 based on multi-network wireless coverage information 315 for the travel route 314. According to aspects to the disclosure, the joint TN/NTN wireless communication configuration 322 can specify how (or whether) UE 305 is to use each of multiple wireless communication networks over the course of its travel over travel route 314. In some examples, the multiple wireless communication networks can include one or more terrestrial wireless communication networks and one or more non-terrestrial wireless communication networks. For instance, in some examples, the joint TN/NTN wireless communication configuration 322 can indicate how (or whether) UE 305 uses wireless data coverage of RAN 303A as it traverses travel route 314, and how (or whether) UE 305 is to use wireless data coverage of an SBWC network (such as one associated with satellite(s) 204 of FIG. 2) as it traverses travel route 314. In some examples, the joint TN/NTN wireless communication configuration 322 can indicate how (or whether) UE 305 is to use coverage of multiple wireless communication networks in tandem as it traverses travel route 314. For instance, in some examples, the joint TN/NTN wireless communication configuration 322 can indicate how (or whether) UE 305 is to use a dual connectivity mode to perform concurrent wireless data communications via RAN 303A and an SBWC network as it traverses travel route 314.

According to aspects of the disclosure, the multi-network wireless coverage information 315 can describe aspects of wireless coverage of multiple wireless communication networks in a geographical area (such as geographical area 201) of the travel route 314. In some examples, for any given one of the multiple wireless communication networks, such aspects can include regions in which wireless coverage is or is not available, timings associated with changes in wireless coverage availability, indications of relative strengths or qualities of wireless coverage in various regions, or other information.

As shown in FIG. 3, multi-network wireless coverage information 315 can include terrestrial network wireless coverage information 316. According to aspects of the disclosure, terrestrial network wireless coverage information 316 can describe aspects of wireless coverage of one or more terrestrial wireless communication networks in the geographical area of the travel route 314. In some examples, the one or more terrestrial wireless communication networks can include RAN 303. In some examples, terrestrial network wireless coverage information 316 can include information indicating coverage areas of cells of RAN 303 that are located in the geographical area of the travel route 314. In some examples, terrestrial network wireless coverage information 316 can additionally or alternatively include information indicating one or more regions in the geographical area of the travel route 314 that are not within coverage of any cells of RAN 303.

As also shown in FIG. 3, multi-network wireless coverage information 315 can include non-terrestrial network wireless coverage information 317. According to aspects of the disclosure, non-terrestrial network wireless coverage information 317 can describe aspects of one or more non-terrestrial wireless communication networks in the geographical area of the travel route 314. In some examples, the one or more non-terrestrial wireless communication networks can include a satellite-based wireless communication (SBWC) network, such as one that may provide NTN wireless coverage in the geographical area of the travel route 314 using satellite(s) 204 of FIG. 2. In some examples, non-terrestrial network wireless coverage information 317 can include information indicating one or more regions in the geographical area of the travel route 314 that are not, or will not, be in coverage of the SBWC network. In some examples, non-terrestrial network wireless coverage information 317 can include information indicating non-covered regions as a function of time. For instance, in some examples, the non-terrestrial network wireless coverage information 317 may include a dynamic NTN coverage map that indicates locations that are or are not in NTN coverage based on a time of day. In some examples, such time-based indications can be derived based on expected motion of satellite(s) of the SWBC network, such as may be determined based on a schedule describing substantially deterministic motion of such satellite(s) in Earth orbit.

According to aspects of the disclosure, based on multi-network wireless coverage information 315, network node 360 can determine whether, with respect to one or more wireless communication networks, UE 305 will encounter any regions of diminished or absent wireless data coverage in conjunction with traversing travel route 314. For instance, network node 360 can determine based on terrestrial network wireless coverage information 316 included in multi-network wireless coverage information 315 whether UE 305 will encounter any regions of diminished or absent coverage of RAN 303A in conjunction with traversing travel route 314, and can determine based on non-terrestrial network wireless coverage information 317 included in multi-network wireless coverage information 315 whether UE 305 will encounter any regions of diminished or absent coverage of an SBWC network in conjunction with traversing travel route 314.

According to aspects of the disclosure, with respect to one or more wireless communication networks with respect to which the coverage region(s) (and thus, the non-covered regions) vary with time, network node 360 can determine whether UE 305 will encounter region(s) of diminished or absent coverage in conjunction with traversing travel route 314 based on multi-network wireless coverage information 315 associated with those network(s) and on timing parameters 318. Timing parameters 318 can include parameters or other information describing expectations regarding timing-related aspect(s) of UE 305's travel over travel route 314. In some examples, timing parameters 318 can indicate any or all of an expected time of day, start time, end time, duration, or other timing-related aspect of UE 305's travel over travel route 314. In some examples, the network node 360 can determine based on timing parameters 318 an estimated time at which the UE 305 will reach a particular point or region along travel route 314, and can determine based on non-terrestrial network wireless coverage information 317 whether that point or region will be in coverage of an SWBC network at that estimated time.

According to aspects of the disclosure, network node 360 can design the joint TN/NTN wireless communication configuration 322 to account for instances of diminished or absent wireless data coverage that—based on multi-network wireless coverage information 315 and in some examples, based also on timing parameters 318—it expects UE 305 to encounter as UE 305 traverses travel route 314. In this context, in some examples, network node 360 can consider one or more quality of experience (QoE) criteria 319 for UE 305 in crafting the joint TN/NTN wireless communication configuration 322. According to aspects of the disclosure, QoE criteria 319 can indicate conditions to be satisfied in order to provide UE 305 with an acceptable QoE, and network node 360 can design the joint TN/NTN wireless communication configuration 322 to satisfy those conditions, so that UE 305 will be provided with an acceptable QoE over the course of traversing travel route 314. In some examples, QoE criteria 319 can indicate desired characteristics with respect to wireless data coverage available to the UE 305 along the travel route 314, such as a desired data rate, latency, reliability, or the like.

In some examples, joint TN/NTN wireless communication configuration 322 can indicate a region, along travel route 314, in which UE 305 is to refrain from use of a non-terrestrial network, such as an SWBC network, for wireless data communications. In some examples, that region may be one in which coverage of the SWBC network expected to be diminished or absent when it is traversed by UE 305, given the timing of UE 305's travel over the travel route 314. In some examples, the joint TN/NTN wireless communication configuration 322 may indicate that the UE 305 is to use a first non-terrestrial network for wireless data communications in a first region along the travel route 314, and is to use a second non-terrestrial network for wireless data communications in a second region along the travel route 314. For instance, in a region along travel route 314 in which coverage of a first SWBC network is expected to be diminished or absent when it is traversed by UE 305, the joint TN/NTN wireless communication configuration 322 may indicate that the UE 305 is to use a second SWBC network for wireless data communications, while the joint TN/NTN wireless communication configuration 322 may indicate that the UE 305 is to use the first SWBC network in other region(s) along travel route 314.

In some examples, the joint TN/NTN wireless communication configuration 322 may indicate a region, along the travel route 314, in which the UE 305 is to perform wireless data communication in a dual-connectivity mode using both a terrestrial network and a non-terrestrial network. For example, joint TN/NTN wireless communication configuration 322 may indicate a region along travel route 314 in which UE 305 is to perform wireless data communication in dual-connectivity mode using RAN 303A and an SBWC network (such as may include satellite(s) 204 of FIG. 2). In some examples, by operating in the dual-connectivity mode in the indicated region, the UE 305 may be able to accumulate enough buffered data to maintain, in a subsequent region of degraded or absent TN or NTN coverage, a threshold level of performance or quality (such as of video playback, for instance) associated with one or more of the QoE criteria 319.

In some examples, travel route 314 can be selected from among multiple candidate routes 313 for travel of UE 305 from the start location to the destination location. In some examples, network node 360 can identify the candidate routes 313 based on position and destination information 312 received from UE 305. In some other examples, an application server 380 can identify the candidate routes 313 based on position and destination information 312, and can notify the network node 360 of the candidate routes 313. In some examples, based on the multi-network wireless coverage information 315 (and possibly also based on timing parameters 318), the network node 360 can identify, as travel route 314, a candidate route 313 over which UE 305 is expected to enjoy a best quality of experience according to QoE criteria 319.

According to aspects of the disclosure, network node 360 can send the joint TN/NTN wireless communication configuration 322 to UE 305. In some examples, such as the example shown in FIG. 3, network node 360 can send the joint TN/NTN wireless communication configuration 322 to UE 305 by sending, to UE 305, configuration information (such as one or more messages 320) that indicates the joint TN/NTN wireless communication configuration 322. In some such examples, the configuration information can also indicate the travel route 314. In some examples, network node 360 can send the joint TN/NTN wireless communication configuration 322 to UE 305 by providing the joint TN/NTN wireless communication configuration 322 to a RAN node (such as a gNB, ng-eNB, or eNB) of RAN 303A, and the RAN node can relay the joint TN/NTN wireless communication configuration 322 via control signaling in RAN 303 (such as in one or more radio resource control (RRC) messages).

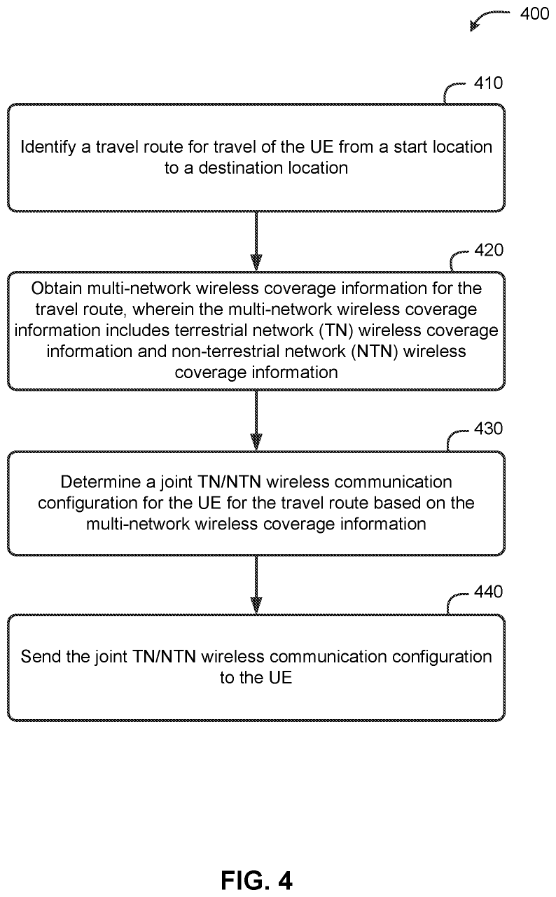

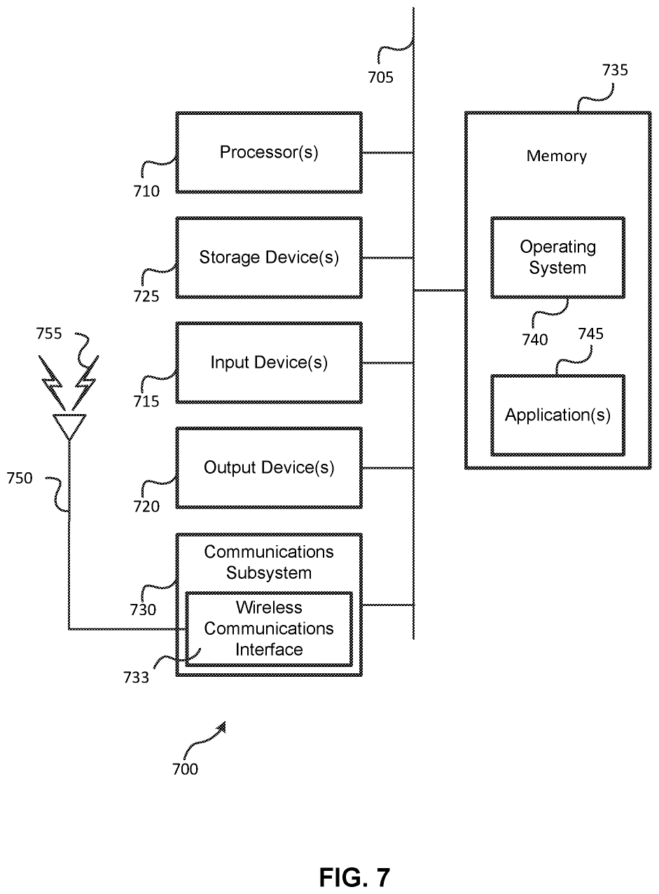

FIG. 4 is a block diagram showing an example method 400 for coverage-aware joint configuration for multi-network wireless communication, according to an embodiment. In some implementations, means for performing the functionality illustrated in one or more of the blocks shown in FIG. 4 may be performed by hardware and/or software components of a computer system. Example components of a computer system are illustrated in FIG. 7, which is described in more detail below. In some examples, network node 360 may perform the functionality illustrated in one or more of the blocks shown in FIG. 4 in operating environment 300 of FIG. 3.

At block 410, the functionality comprises identifying a travel route for travel of the UE from a start location to a destination location. For example, in operating environment 300 of FIG. 3, network node 360 may identify a travel route 314 (such as travel route A or travel route B of FIG. 2) for travel of UE 305 from a start location to a destination location (such as from start location 210 to destination location 211 in FIG. 2). Means for performing functionality at block 410 may comprise a bus 705, processors 710, communications subsystem 730, memory 735, and/or other components of a computer system, as illustrated in FIG. 7. In some examples, the travel route can be selected from among multiple candidate travel routes. For example, in operating environment 300 of FIG. 3, multiple candidate routes 313 can be identified (by network node 360 or application server 380) for travel of UE 305 from the start location to the destination location, and the travel route 314 can be selected from among those candidate routes 313.

At block 420, the functionality comprises obtaining multi-network wireless coverage information for the travel route, wherein the multi-network wireless coverage information includes terrestrial network (TN) wireless coverage information and non-terrestrial network (NTN) wireless coverage information. For example, in operating environment 300 of FIG. 3, network node 360 may obtain multi-network wireless coverage information 315, which may include terrestrial network wireless coverage information 316 and non-terrestrial network wireless coverage information 317. Means for performing functionality at block 420 may comprise a bus 705, processors 710. communications subsystem 730, memory 735, and/or other components of a computer system, as illustrated in FIG. 7. In some examples, the NTN wireless coverage information may include a dynamic NTN coverage map that indicates locations that are or are not in NTN coverage based on a time of day.

At block 430, the functionality comprises determining a joint TN/NTN wireless communication configuration for the UE for the travel route based on the multi-network wireless coverage information. For example, in operating environment 300 of FIG. 3, network node 360 may determine joint TN/NTN wireless communication configuration 322 for UE 305 for the travel route 314 based on multi-network wireless coverage information 315. Means for performing functionality at block 430 may comprise a bus 705, processors 710, communications subsystem 730, memory 735, and/or other components of a computer system, as illustrated in FIG. 7. In some examples, the joint TN/NTN wireless communication configuration may indicate a region, along the travel route, in which the UE is to refrain from use of a non-terrestrial network for wireless data communications. For example, in operating environment 300 of FIG. 3, travel route 314 may correspond to travel route B of FIG. 2, and joint TN/NTN wireless communication configuration 322 may indicate that UE 305 is to refrain from using a non-terrestrial network for wireless data communication in region 208 of FIG. 2.

In some examples, the joint TN/NTN wireless communication configuration may indicate that the UE is to use a first non-terrestrial network for wireless data communications in a first region along the travel route, and is to use a second non-terrestrial network for wireless data communications in a second region along the travel route. For example, in operating environment 300 of FIG. 3, travel route 314 may correspond to travel route B of FIG. 2, and joint TN/NTN wireless communication configuration 322 may indicate that UE 305 is to use a first non-terrestrial network for wireless data communications while traversing the portion of travel route B located in region 208 of FIG. 2, and is to use a second non-terrestrial network for wireless data communications for the remainder of travel route B once it exits region 208.

In some examples, the joint TN/NTN wireless communication configuration may indicate a region, along the travel route, in which the UE is to perform wireless data communication in a dual-connectivity mode using both a terrestrial network and a non-terrestrial network. For example, in operating environment 300 of FIG. 3, travel route 314 may correspond to travel route A of FIG. 2, and joint TN/NTN wireless communication configuration 322 may indicate that in a region of cell 202-2 that contains a portion of travel route A adjacent to that contained in region 206, UE 305 is to perform wireless data communication in a dual-connectivity mode using both a terrestrial network associated with cell 202-2 and a non-terrestrial network associated with satellite(s) 204. In some examples, the joint TN/NTN wireless communication configuration may indicate a second region, along the travel route, in which the UE is to exit the dual-connectivity mode and perform wireless data communication using either the terrestrial network or the non-terrestrial network. For instance, continuing the preceding example, joint TN/NTN wireless communication configuration 322 may indicate that in region 206 of FIG. 2, UE 305 is to exit the dual-connectivity mode and perform wireless data communication using the non-terrestrial network associated with satellite(s) 204.

In some examples, determining the joint TN/NTN wireless communication configuration may include determining the joint TN/NTN wireless communication configuration for the UE for the travel route based on the multi-network wireless coverage information and a time of day of the travel of the UE. For example, in operating environment 300 of FIG. 3, non-terrestrial network wireless coverage information 317 can indicate locations that are or are not in NTN coverage depending on time of day, and in determining joint TN/NTN wireless communication configuration 322, network node 360 can consult non-terrestrial network wireless coverage information 317 to identify locations that are or are not in NTN coverage along the travel route 314 of UE 305 and determine joint TN/NTN wireless communication configuration 322 accordingly.

In some examples, determining the joint TN/NTN wireless communication configuration may include identifying, based on the NTN wireless coverage information and the time of day, a region along the travel route within which wireless coverage of a non-terrestrial network is diminished. For example, in operating environment 300 of FIG. 3, network node 360 can identify, based on non-terrestrial network wireless coverage information 317 and the time of day of the travel of UE 305, the region 208 of FIG. 2 as one along travel route B within which wireless coverage of the non-terrestrial network associated with satellite(s) 204 is diminished. In some examples, the joint TN/NTN wireless communication configuration can indicate that the UE is to use an alternate non-terrestrial network for wireless data communication in the region along the travel route. For instance, continuing the preceding example, the joint TN/NTN wireless communication configuration 322 can indicate that UE 305 is to use an alternate non-terrestrial network for wireless data communication in region 208 of FIG. 2. In some other examples, the joint TN/NTN wireless communication configuration can indicate that the UE is to refrain from wireless data communication via non-terrestrial networks in the region along the travel route. For instance, continuing the preceding example, rather than indicating an alternate non-terrestrial network for use by UE 305 for wireless data communications in region 208 of FIG. 2, joint TN/NTN wireless communication configuration 322 can indicate that UE 305 is to refrain from wireless data communication via non-terrestrial networks in region 208.

In some examples, determining the joint TN/NTN wireless communication configuration may include determining the joint TN/NTN wireless communication configuration for the UE for the travel route based on the TN wireless coverage information, the NTN wireless coverage information, and one or more quality of experience (QoE) criteria for the UE. For example, in operating environment 300 of FIG. 3, network node 360 may determine the joint TN/NTN wireless communication configuration 322 for UE 305 for the travel route 314 based on the terrestrial network wireless coverage information 316, the non-terrestrial network wireless coverage information 317, and one or more QoE criteria 319. In some examples, the one or more QoE criteria may indicate desired characteristics with respect to wireless data coverage available to the UE along the travel route, such as a desired data rate, latency, reliability, or the like. In some examples, based on the one or more QoE criteria, the joint TN/NTN wireless communication configuration may be selected so as to provide the UE with an increased data rate in a portion of the travel route preceding a region of degraded or absent TN or NTN coverage. In some examples, such an increased data rate can enable the UE to implement sufficient buffering to maintain, while in the region of degraded or absent TN or NTN coverage, a threshold level of performance or quality (such as of video playback, for instance) associated with one or more of the QoE criteria.

In some examples, the multi-network wireless coverage information can be used to select the travel route for the UE from among multiple candidate travel routes. For example, in operating environment 300 of FIG. 3, network node 360 can identify multiple candidate routes 313 for travel of UE 305 from a start location to a destination location, and can select travel route 314 from among the multiple candidate routes 313 based on multi-network wireless coverage information 315. In some examples, the travel route can be selected from among the multiple candidate travel routes based on the multi-network wireless coverage information and the time of day of the travel of the UE. For instance, continuing with the preceding example, network node 360 can consult non-terrestrial network wireless coverage information 317 to assess the availability of NTN wireless coverage along the various candidate routes 313, and can consider that assessment in selecting travel route 314 (such as by selecting a candidate route 313 that features uninterrupted NTN wireless coverage, for example).

At block 440, the functionality comprises sending the joint TN/NTN wireless communication configuration to the UE. For example, in operating environment 300 of FIG. 3, network node 360 may send configuration information (such as one or more messages 320) to UE 305, and the configuration information may indicate joint TN/NTN wireless communication configuration 322. Means for performing functionality at block 440 may comprise a bus 705, processors 710, communications subsystem 730, memory 735, and/or other components of a computer system, as illustrated in FIG. 7. In some examples, the configuration information can indicate the travel route. For example, in operating environment 300 of FIG. 3, configuration information (such as one or more messages 320) that network node 360 sends to UE 305 can indicate a travel route (such as travel route A or B of FIG. 2) for UE 305 as well as a joint TN/NTN wireless communication configuration 322 for that travel route.

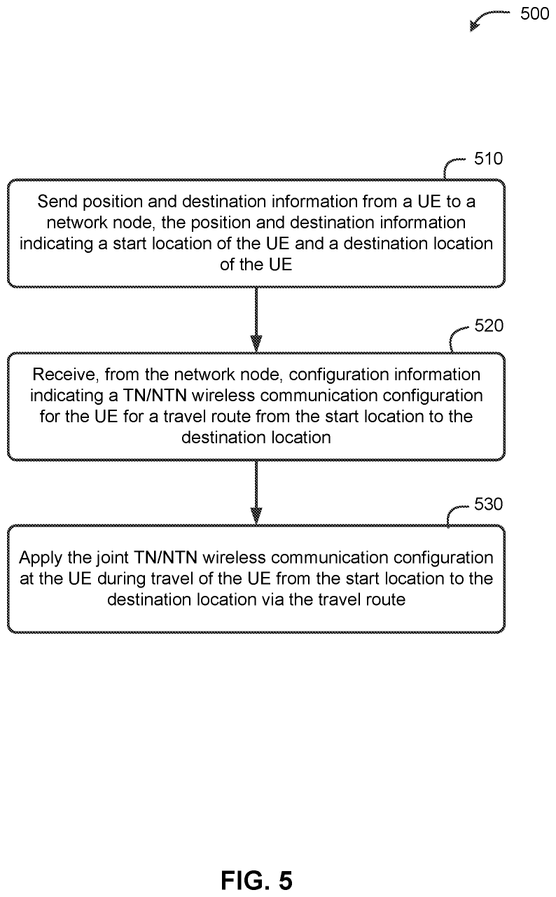

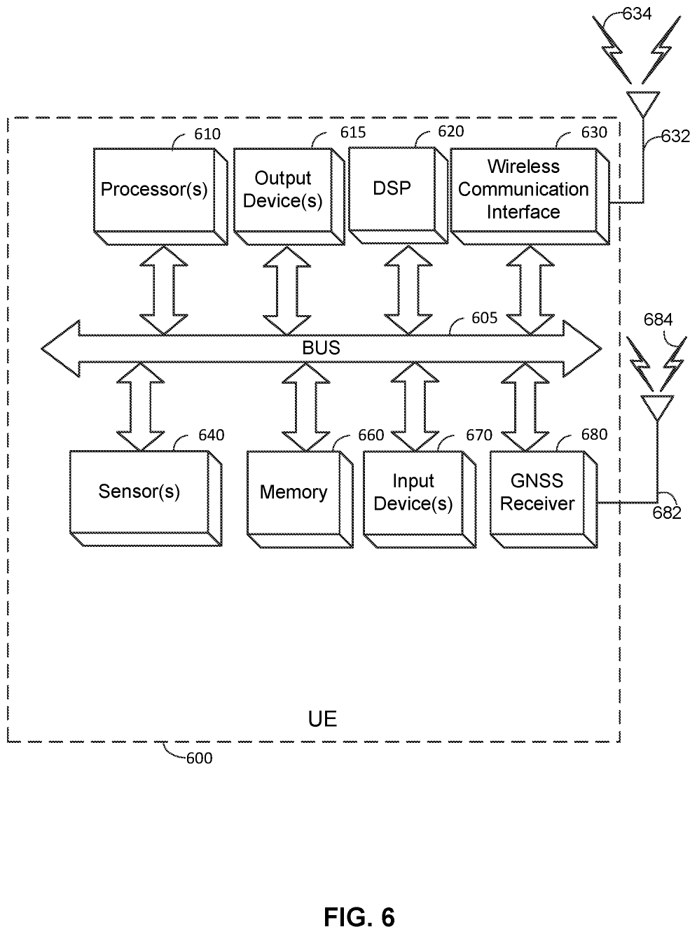

FIG. 5 is a block diagram showing an example method 500 for coverage-aware joint configuration for multi-network wireless communication, according to an embodiment. In some implementations, means for performing the functionality illustrated in one or more of the blocks shown in FIG. 5 may be performed by hardware and/or software components of a UE. Example components of a UE are illustrated in FIG. 6, which is described in more detail below. In some examples, UE 305 may perform the functionality illustrated in one or more of the blocks shown in FIG. 5 in operating environment 300 of FIG. 3.

At block 510, the functionality comprises sending position and destination information from the UE to a network node, the position and destination information indicating a start location of the UE and a destination location of the UE. For example, in operating environment 300 of FIG. 3, UE 305 may send position and destination information 312 to network node 360, and position and destination information 312 may indicate a start location of UE 305 and a destination location of UE 305 (such as start location 210 and destination location 211 of FIG. 2). Means for performing functionality at block 510 may comprise a bus 605, processors 610, communications subsystem 630, memory 635, and/or other components of a UE, as illustrated in FIG. 6.

At block 520, the functionality comprises receiving, from the network node, configuration information indicating a joint TN/NTN wireless communication configuration for the UE for a travel route from the start location to the destination location. For example, in operating environment 300 of FIG. 3, UE 305 may receive, from network node 360, configuration information (e.g., one or more messages 320) indicating a joint TN/NTN wireless communication configuration 322 for UE 305 for a travel route 314 (such as travel route A or travel route B of FIG. 2) from the start location indicated by position and destination information 312 to the destination location indicated by position and destination information 312. Means for performing functionality at block 510 may comprise a bus 605, processors 610, communications subsystem 630, memory 635, and/or other components of a UE, as illustrated in FIG. 6. In some examples, the joint TN/NTN wireless communication configuration may indicate a region, along the travel route, in which the UE is to refrain from use of a non-terrestrial network for wireless data communications. For example, in operating environment 300 of FIG. 3, travel route 314 may correspond to travel route B of FIG. 2, and joint TN/NTN wireless communication configuration 322 may indicate that UE 305 is to refrain from using a non-terrestrial network for wireless data communication in region 208 of FIG. 2.

In some examples, the joint TN/NTN wireless communication configuration may indicate that the UE is to use a first non-terrestrial network for wireless data communications in a first region along the travel route, and is to use a second non-terrestrial network for wireless data communications in a second region along the travel route. For example, in operating environment 300 of FIG. 3, travel route 314 may correspond to travel route B of FIG. 2, and joint TN/NTN wireless communication configuration 322 may indicate that UE 305 is to use a first non-terrestrial network for wireless data communications while traversing the portion of travel route B located in region 208 of FIG. 2, and is to use a second non-terrestrial network for wireless data communications for the remainder of travel route B once it exits region 208.

At block 530, the functionality comprises applying the joint TN/NTN wireless communication configuration at the UE during travel of the UE from the start location to the destination location via the travel route. For example, in operating environment 300 of FIG. 3, UE 305 may apply joint TN/NTN wireless communication configuration 322 during travel, via travel route 314, from the start location indicated by position and destination information 312 to the destination location indicated by position and destination information 312. Means for performing functionality at block 510 may comprise a bus 605, processors 610, communications subsystem 630, memory 635, and/or other components of a UE, as illustrated in FIG. 6.

FIG. 6 is a block diagram of an embodiment of a UE 600, which can be utilized as described herein above (e.g., in association with FIG. 1-4). It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 6.

The UE 600 is shown comprising hardware elements that can be electrically coupled via a bus 605 (or may otherwise be in communication, as appropriate). The hardware elements may include a processor(s) 610 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 610 may comprise one or more processing units, which may be housed in a single integrated circuit (IC) or multiple ICs. As shown in FIG. 6, some embodiments may have a separate DSP 620, depending on desired functionality. Location determination and/or other determinations based on wireless communication may be provided in the processor(s) 610 and/or wireless communication interface 630 (discussed below). The UE 600 also can include one or more input devices 670, which can include without limitation one or more keyboards, touch screens, touch pads, microphones, buttons, dials, switches, and/or the like; and one or more output devices 615, which can include without limitation one or more displays (e.g., touch screens), light emitting diodes (LEDs), speakers, and/or the like.

The UE 600 may also include a wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 600 to communicate with other devices as described in the embodiments above. The wireless communication interface 630 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 632 that send and/or receive wireless signals 634. According to some embodiments, the wireless communication antenna(s) 632 may comprise a plurality of discrete antennas, antenna arrays, or any combination thereof. The antenna(s) 632 may be capable of transmitting and receiving wireless signals using beams (e.g., Tx beams and Rx beams). Beam formation may be performed using digital and/or analog beam formation techniques, with respective digital and/or analog circuitry. The wireless communication interface 630 may include such circuitry.

Depending on desired functionality, the wireless communication interface 630 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 600 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 600 can further include sensor(s) 640. Sensor(s) 640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 600 may also include a Global Navigation Satellite System (GNSS) receiver 680 capable of receiving signals 684 from one or more GNSS satellites using an antenna 682 (which could be the same as antenna 632). Positioning based on GNSS signal measurement can be utilized to complement and/or incorporate the techniques described herein. The GNSS receiver 680 can extract a position of the UE 600. using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 680 is illustrated in FIG. 6 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 610, DSP 620, and/or a processor within the wireless communication interface 630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 610 or DSP 620.

The UE 600 may further include and/or be in communication with a memory 660. The memory 660 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 660 of the UE 600 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the UE 600 (and/or processor(s) 610 or DSP 620 within UE 600). In some embodiments, then, such code and/or instructions can be used to configure and/or adapt a general-purpose computer (or other device) to perform one or more operations in accordance with the described methods.

FIG. 7 is a block diagram of an embodiment of a computer system 700, which may be used, in whole or in part, to provide the functions of one or more network components as described in the embodiments herein, such as one or both of network node 360 and application server 380 of FIG. 3. In some examples, computer system 700 can perform one or more operations associated with the method 400 for coverage-aware joint configuration for multi-network wireless communication of FIG. 4. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different geographical locations.

The computer system 700 is shown comprising hardware elements that can be electrically coupled via a bus 705 (or may otherwise be in communication, as appropriate). The hardware elements may include processor(s) 710, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 700 also may comprise one or more input devices 715, which may comprise without limitation a mouse, a keyboard, a camera, a microphone, and/or the like; and one or more output devices 720, which may comprise without limitation a display device, a printer, and/or the like.

The computer system 700 may further include (and/or be in communication with) one or more non-transitory storage devices 725, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 700 may also include a communications subsystem 730. which may comprise wireless communication technologies managed and controlled by a wireless communication interface 733, as well as wired technologies (such as Ethernet, coaxial communications, universal serial bus (USB), and the like). The wireless communication interface 733 may comprise one or more wireless transceivers that may send and receive wireless signals 755 (e.g., signals according to 5G NR or LTE) via wireless antenna(s) 750. Thus the communications subsystem 730 may comprise a modem, a network card (wireless or wired), an infrared communication device, a wireless communication device, and/or a chipset, and/or the like, which may enable the computer system 700 to communicate on any or all of the communication networks described herein to any device on the respective network, including a User Equipment (UE), base stations and/or other TRPs, and/or any other electronic devices described herein. Hence, the communications subsystem 730 may be used to receive and send data as described in the embodiments herein.

In many embodiments, the computer system 700 will further comprise a working memory 735, which may comprise a RAM or ROM device, as described above. Software elements, shown as being located within the working memory 735, may comprise an operating system 740, device drivers, executable libraries, and/or other code, such as one or more applications 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C. here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method for configuring multi network wireless communication of a user equipment (UE), including identifying a travel route for travel of the UE from a start location to a destination location, obtaining multi network wireless coverage information for the travel route, where the multi network wireless coverage information includes terrestrial network (TN) wireless coverage information and non terrestrial network (NTN) wireless coverage information, determining a joint TN/NTN wireless communication configuration for the UE for the travel route based on the multi network wireless coverage information, and sending the joint TN/NTN wireless communication configuration to the UE.

Clause 2. The method of clause 1, where the joint TN/NTN wireless communication configuration indicates a region, along the travel route, in which the UE is to refrain from use of a non terrestrial network for wireless data communications.

Clause 3. The method of any of clauses 1 to 2, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 4. The method of any of clauses 1 to 3, where the joint TN/NTN wireless communication configuration indicates a region, along the travel route, in which the UE is to perform wireless data communication in a dual-connectivity mode using both a terrestrial network and a non-terrestrial network.

Clause 5. The method of clause 4, where the joint TN/NTN wireless communication configuration indicates a second region, along the travel route, in which the UE is to exit the dual connectivity mode and perform wireless data communication using either the terrestrial network or the non terrestrial network.

Clause 6. The method of any of clauses 1 to 5, where determining the joint TN/NTN wireless communication configuration includes determining the joint TN/NTN wireless communication configuration for the UE for the travel route based on the multi network wireless coverage information and a time of day of the travel of the UE.

Clause 7. The method of clause 6, where determining the joint TN/NTN wireless communication configuration includes identifying, based on the NTN wireless coverage information and the time of day, a region along the travel route within which wireless coverage of a non terrestrial network is diminished.

Clause 8. The method of clause 7, where the joint TN/NTN wireless communication configuration indicates that the UE is to use an alternate non terrestrial network for wireless data communication in the region along the travel route.

Clause 9. The method of clause 7, where the joint TN/NTN wireless communication configuration indicates that the UE is to refrain from wireless data communication via non terrestrial networks in the region along the travel route.

Clause 10. The method of any of clauses 1 to 9, further including selecting the travel route from among multiple candidate travel routes based on the multi-network wireless coverage information and a time of day of the travel of the UE.

Clause 11. The method of any of clauses 1 to 10, where determining the joint TN/NTN wireless communication configuration includes determining the joint TN/NTN wireless communication configuration for the UE for the travel route based on the TN wireless coverage information, the NTN wireless coverage information, and one or more quality of experience (QoE) criteria for the UE.

Clause 12. The method of any of clauses 1 to 11, where sending the joint TN/NTN wireless communication configuration to the UE includes sending, to the UE, configuration information that indicates the joint TN/NTN wireless communication configuration and the travel route.

Clause 13. An apparatus for configuring multi network wireless communication of a user equipment (UE), including at least one memory, at least one transceiver, and at least one processor coupled to the at least one memory and the at least one transceiver, the at least one processor configured to identify a travel route for travel of the UE from a start location to a destination location, obtain multi network wireless coverage information for the travel route, where the multi network wireless coverage information includes terrestrial network (TN) wireless coverage information and non terrestrial network (NTN) wireless coverage information, determine a joint TN/NTN wireless communication configuration for the UE for the travel route based on the multi network wireless coverage information, and send, via the at least one transceiver, the joint TN/NTN wireless communication configuration to the UE.

Clause 14. The apparatus of clause 13, where the joint TN/NTN wireless communication configuration indicates a region, along the travel route, in which the UE is to refrain from use of a non terrestrial network for wireless data communications.

Clause 15. The apparatus of any of clauses 13 to 14, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 16. The apparatus of any of clauses 13 to 15, where the joint TN/NTN wireless communication configuration indicates a region, along the travel route, in which the UE is to perform wireless data communication in a dual-connectivity mode using both a terrestrial network and a non-terrestrial network.

Clause 17. The apparatus of clause 16, where the joint TN/NTN wireless communication configuration indicates a second region, along the travel route, in which the UE is to exit the dual connectivity mode and perform wireless data communication using either the terrestrial network or the non terrestrial network.

Clause 18. The apparatus of any of clauses 13 to 17, where to determine the joint TN/NTN wireless communication configuration, the at least one processor is configured to determine the joint TN/NTN wireless communication configuration for the UE for the travel route based on the multi network wireless coverage information and a time of day of the travel of the UE.

Clause 19. The apparatus of clause 18, where to determine the joint TN/NTN wireless communication configuration, the at least one processor is configured to identify, based on the NTN wireless coverage information and the time of day, a region along the travel route within which wireless coverage of a non terrestrial network is diminished.

Clause 20. The apparatus of clause 19, where the joint TN/NTN wireless communication configuration indicates that the UE is to use an alternate non terrestrial network for wireless data communication in the region along the travel route.

Clause 21. The apparatus of clause 19, where the joint TN/NTN wireless communication configuration indicates that the UE is to refrain from wireless data communication via non terrestrial networks in the region along the travel route.

Clause 22. The apparatus of any of clauses 13 to 21, where the at least one processor is further configured to select the travel route from among multiple candidate travel routes based on the multi-network wireless coverage information and a time of day of the travel of the UE.

Clause 23. The apparatus of any of clauses 13 to 22, where to determine the joint TN/NTN wireless communication configuration, the at least one processor is configured to determine the joint TN/NTN wireless communication configuration for the UE for the travel route based on the TN wireless coverage information, the NTN wireless coverage information, and one or more quality of experience (QoE) criteria for the UE.

Clause 24. The apparatus of any of clauses 13 to 23, where to send the joint TN/NTN wireless communication configuration to the UE, the at least one processor is configured to send, to the UE, configuration information that indicates the joint TN/NTN wireless communication configuration and the travel route.

Clause 25. An apparatus for configuring multi network wireless communication of a user equipment (UE), including means for identifying a travel route for travel of the UE from a start location to a destination location, means for obtaining multi network wireless coverage information for the travel route, where the multi network wireless coverage information includes terrestrial network (TN) wireless coverage information and non terrestrial network (NTN) wireless coverage information, means for determining a joint TN/NTN wireless communication configuration for the UE for the travel route based on the multi network wireless coverage information, and means for sending the joint TN/NTN wireless communication configuration to the UE.

Clause 26. The apparatus of clause 25, where the joint TN/NTN wireless communication configuration indicates a region, along the travel route, in which the UE is to refrain from use of a non terrestrial network for wireless data communications.

Clause 27. The apparatus of any of clauses 25 to 26, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 28. The apparatus of any of clauses 25 to 27, where the joint TN/NTN wireless communication configuration indicates a region, along the travel route, in which the UE is to perform wireless data communication in a dual-connectivity mode using both a terrestrial network and a non-terrestrial network.

Clause 29. The apparatus of clause 28, where the joint TN/NTN wireless communication configuration indicates a second region, along the travel route, in which the UE is to exit the dual connectivity mode and perform wireless data communication using either the terrestrial network or the non terrestrial network.

Clause 30. The apparatus of any of clauses 25 to 29, where the means for determining the joint TN/NTN wireless communication configuration includes means for determining the joint TN/NTN wireless communication configuration for the UE for the travel route based on the multi network wireless coverage information and a time of day of the travel of the UE.

Clause 31. The apparatus of clause 30, where the means for determining the joint TN/NTN wireless communication configuration includes means for identifying. based on the NTN wireless coverage information and the time of day, a region along the travel route within which wireless coverage of a non terrestrial network is diminished.

Clause 32. The apparatus of clause 31, where the joint TN/NTN wireless communication configuration indicates that the UE is to use an alternate non terrestrial network for wireless data communication in the region along the travel route.

Clause 33. The apparatus of clause 31, where the joint TN/NTN wireless communication configuration indicates that the UE is to refrain from wireless data communication via non terrestrial networks in the region along the travel route.

Clause 34. The apparatus of any of clauses 25 to 33, further including means for selecting the travel route from among multiple candidate travel routes based on the multi-network wireless coverage information and a time of day of the travel of the UE.

Clause 35. The apparatus of any of clauses 25 to 34, where the means for determining the joint TN/NTN wireless communication configuration includes means for determining the joint TN/NTN wireless communication configuration for the UE for the travel route based on the TN wireless coverage information, the NTN wireless coverage information, and one or more quality of experience (QoE) criteria for the UE.

Clause 36. The apparatus of any of clauses 25 to 35, where the means for sending the joint TN/NTN wireless communication configuration to the UE includes means for sending, to the UE, configuration information that indicates the joint TN/NTN wireless communication configuration and the travel route.

Clause 37. A non-transitory computer-readable medium storing instructions for configuring multi network wireless communication of a user equipment (UE), the instructions including code to identify a travel route for travel of the UE from a start location to a destination location, obtain multi network wireless coverage information for the travel route, where the multi network wireless coverage information includes terrestrial network (TN) wireless coverage information and non terrestrial network (NTN) wireless coverage information, determine a joint TN/NTN wireless communication configuration for the UE for the travel route based on the multi network wireless coverage information, and send the joint TN/NTN wireless communication configuration to the UE.

Clause 38. The non-transitory computer-readable medium of clause 37, where the joint TN/NTN wireless communication configuration indicates a region, along the travel route, in which the UE is to refrain from use of a non terrestrial network for wireless data communications.

Clause 39. The non-transitory computer-readable medium of any of clauses 37 to 38, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 40. The non-transitory computer-readable medium of any of clauses 37 to 39, where the joint TN/NTN wireless communication configuration indicates a region, along the travel route, in which the UE is to perform wireless data communication in a dual-connectivity mode using both a terrestrial network and a non-terrestrial network.

Clause 41. The non-transitory computer-readable medium of clause 40, where the joint TN/NTN wireless communication configuration indicates a second region, along the travel route, in which the UE is to exit the dual connectivity mode and perform wireless data communication using either the terrestrial network or the non terrestrial network.

Clause 42. The non-transitory computer-readable medium of any of clauses 37 to 41, where determining the joint TN/NTN wireless communication configuration includes determining the joint TN/NTN wireless communication configuration for the UE for the travel route based on the multi network wireless coverage information and a time of day of the travel of the UE.

Clause 43. The non-transitory computer-readable medium of clause 42, where determining the joint TN/NTN wireless communication configuration includes identifying, based on the NTN wireless coverage information and the time of day, a region along the travel route within which wireless coverage of a non terrestrial network is diminished.

Clause 44. The non-transitory computer-readable medium of clause 43, where the joint TN/NTN wireless communication configuration indicates that the UE is to use an alternate non terrestrial network for wireless data communication in the region along the travel route.

Clause 45. The non-transitory computer-readable medium of clause 43, where the joint TN/NTN wireless communication configuration indicates that the UE is to refrain from wireless data communication via non terrestrial networks in the region along the travel route.

Clause 46. The non-transitory computer-readable medium of any of clauses 37 to 45, the instructions including code to select the travel route from among multiple candidate travel routes based on the multi-network wireless coverage information and a time of day of the travel of the UE.

Clause 47. The non-transitory computer-readable medium of any of clauses 37 to 46, where determining the joint TN/NTN wireless communication configuration includes determining the joint TN/NTN wireless communication configuration for the UE for the travel route based on the TN wireless coverage information, the NTN wireless coverage information, and one or more quality of experience (QoE) criteria for the UE.

Clause 48. The non-transitory computer-readable medium of any of clauses 37 to 47, where sending the joint TN/NTN wireless communication configuration to the UE includes sending. to the UE, configuration information that indicates the joint TN/NTN wireless communication configuration and the travel route.

Clause 49. A method for configuring multi network wireless communication of a user equipment (UE), including sending position and destination information from the UE to a network node, the position and destination information indicating a start location of the UE and a destination location of the UE, receiving, from the network node, configuration information indicating a joint terrestrial network (TN)/non terrestrial network (NTN) wireless communication configuration for the UE for a travel route from the start location to the destination location, and applying the joint TN/NTN wireless communication configuration at the UE during travel of the UE from the start location to the destination location via the travel route.

Clause 50. The method of clause 49, where the joint TN/NTN wireless communication configuration indicates a region, along the travel route, in which the UE is to refrain from use of a non terrestrial network for wireless data communications.

Clause 51. The method of any of clauses 49 to 50, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 52. The method of any of clauses 49 to 51, where the joint TN/NTN wireless communication configuration indicates a region, along the travel route, in which the UE is to perform wireless data communication in a dual-connectivity mode using both a terrestrial network and a non-terrestrial network.

Clause 53. The method of clause 52, where the joint TN/NTN wireless communication configuration indicates a second region, along the travel route, in which the UE is to exit the dual connectivity mode and perform wireless data communication using either the terrestrial network or the non terrestrial network.

Clause 54. An apparatus for configuring multi-network wireless communication of a user equipment (UE), including at least one memory, at least one transceiver, and at least one processor coupled to the at least one memory and the at least one transceiver, the at least one processor configured to send, via the at least one transceiver, position and destination information from the UE to a network node, the position and destination information indicating a start location of the UE and a destination location of the UE, receive, from the network node, via the at least one transceiver, configuration information indicating a joint terrestrial network (TN)/non terrestrial network (NTN) wireless communication configuration for the UE for a travel route from the start location to the destination location, and apply the joint TN/NTN wireless communication configuration at the UE during travel of the UE from the start location to the destination location via the travel route.

Clause 55. The apparatus of clause 54, where the joint TN/NTN wireless communication configuration indicates a region, along the travel route, in which the UE is to refrain from use of a non terrestrial network for wireless data communications.

Clause 56. The apparatus of any of clauses 54 to 55, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 57. The apparatus of any of clauses 54 to 56, where the joint TN/NTN wireless communication configuration indicates a region, along the travel route, in which the UE is to perform wireless data communication in a dual-connectivity mode using both a terrestrial network and a non-terrestrial network.

Clause 58. The apparatus of clause 57, where the joint TN/NTN wireless communication configuration indicates a second region, along the travel route, in which the UE is to exit the dual connectivity mode and perform wireless data communication using either the terrestrial network or the non terrestrial network.

Clause 59. An apparatus for configuring multi network wireless communication of a user equipment (UE), including means for sending position and destination information from the UE to a network node, the position and destination information indicating a start location of the UE and a destination location of the UE, means for receiving, from the network node, configuration information indicating a joint terrestrial network (TN)/non terrestrial network (NTN) wireless communication configuration for the UE for a travel route from the start location to the destination location, and means for applying the joint TN/NTN wireless communication configuration at the UE during travel of the UE from the start location to the destination location via the travel route.

Clause 60. The apparatus of clause 59, where the joint TN/NTN wireless communication configuration indicates a region, along the travel route, in which the UE is to refrain from use of a non terrestrial network for wireless data communications.

Clause 61. The apparatus of any of clauses 59 to 60, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 62. The apparatus of any of clauses 59 to 61, where the joint TN/NTN wireless communication configuration indicates a region, along the travel route, in which the UE is to perform wireless data communication in a dual-connectivity mode using both a terrestrial network and a non-terrestrial network.

Clause 63. The apparatus of clause 62, where the joint TN/NTN wireless communication configuration indicates a second region, along the travel route, in which the UE is to exit the dual connectivity mode and perform wireless data communication using either the terrestrial network or the non terrestrial network.

Clause 64. A non-transitory computer-readable medium storing instructions for configuring multi network wireless communication of a user equipment (UE), the instructions including code to send position and destination information from the UE to a network node, the position and destination information indicating a start location of the UE and a destination location of the UE, receive, from the network node, configuration information indicating a joint terrestrial network (TN)/non terrestrial network (NTN) wireless communication configuration for the UE for a travel route from the start location to the destination location, and apply the joint TN/NTN wireless communication configuration at the UE during travel of the UE from the start location to the destination location via the travel route.

Clause 65. The non-transitory computer-readable medium of clause 64, where the joint TN/NTN wireless communication configuration indicates a region, along the travel route, in which the UE is to refrain from use of a non terrestrial network for wireless data communications.

Clause 66. The non-transitory computer-readable medium of any of clauses 64 to 65, where the joint TN/NTN wireless communication configuration indicates that the UE is to use a first non terrestrial network for wireless data communications in a first region along the travel route, and is to use a second non terrestrial network for wireless data communications in a second region along the travel route.

Clause 67. The non-transitory computer-readable medium of any of clauses 64 to 66, where the joint TN/NTN wireless communication configuration indicates a region, along the travel route, in which the UE is to perform wireless data communication in a dual-connectivity mode using both a terrestrial network and a non-terrestrial network.

Clause 68. The non-transitory computer-readable medium of clause 67, where the joint TN/NTN wireless communication configuration indicates a second region, along the travel route, in which the UE is to exit the dual connectivity mode and perform wireless data communication using either the terrestrial network or the non terrestrial network.

What is claimed is:

1. A method for configuring multi-network wireless communication of a user equipment (UE), comprising:
identifying a travel route for travel of the UE from a start location to a destination location;
obtaining multi-network wireless coverage information for the travel route, wherein the multi-network wireless coverage information includes terrestrial network (TN) wireless coverage information and non-terrestrial network (NTN) wireless coverage information;
determining a joint TN/NTN wireless communication configuration for the UE for the travel route based on the multi-network wireless coverage information; and
sending the joint TN/NTN wireless communication configuration to the UE.

2. The method of claim 1, wherein the joint TN/NTN wireless communication configuration indicates a region, along the travel route, in which the UE is to refrain from use of a non-terrestrial network for wireless data communications.

3. The method of claim 1, wherein the joint TN/NTN wireless communication configuration indicates that the UE is to use a first non-terrestrial network for wireless data communications in a first region along the travel route, and is to use a second non-terrestrial network for wireless data communications in a second region along the travel route.

4. The method of claim 1, wherein the joint TN/NTN wireless communication configuration indicates a region, along the travel route, in which the UE is to perform wireless data communication in a dual-connectivity mode using both a terrestrial network and a non-terrestrial network.

5. The method of claim 4, wherein the joint TN/NTN wireless communication configuration indicates a second region, along the travel route, in which the UE is to exit the dual-connectivity mode and perform wireless data communication using either the terrestrial network or the non-terrestrial network.

6. The method of claim 1, wherein determining the joint TN/NTN wireless communication configuration comprises determining the joint TN/NTN wireless communication configuration for the UE for the travel route based on the multi-network wireless coverage information and a time of day of the travel of the UE.

7. The method of claim 6, wherein determining the joint TN/NTN wireless communication configuration comprises identifying, based on the NTN wireless coverage information and the time of day, a region along the travel route within which wireless coverage of a non-terrestrial network is diminished.

8. The method of claim 7, wherein the joint TN/NTN wireless communication configuration indicates that the UE is to use an alternate non-terrestrial network for wireless data communication in the region along the travel route.

9. The method of claim 7, wherein the joint TN/NTN wireless communication configuration indicates that the UE is to refrain from wireless data communication via non-terrestrial networks in the region along the travel route.

10. The method of claim 1, further comprising selecting the travel route from among multiple candidate travel routes based on the multi-network wireless coverage information and a time of day of the travel of the UE.

11. The method of claim 1, wherein determining the joint TN/NTN wireless communication configuration comprises determining the joint TN/NTN wireless communication configuration for the UE for the travel route based on the TN wireless coverage information, the NTN wireless coverage information, and one or more quality of experience (QoE) criteria for the UE.

12. The method of claim 1, wherein sending the joint TN/NTN wireless communication configuration to the UE comprises sending, to the UE, configuration information that indicates the joint TN/NTN wireless communication configuration and the travel route.

13. An apparatus for configuring multi-network wireless communication of a user equipment (UE), comprising:
at least one memory;
at least one transceiver; and
at least one processor coupled to the at least one memory and the at least one transceiver, the at least one processor configured to:
identify a travel route for travel of the UE from a start location to a destination location;
obtain multi-network wireless coverage information for the travel route, wherein the multi-network wireless coverage information includes terrestrial network (TN) wireless coverage information and non-terrestrial network (NTN) wireless coverage information;
determine a joint TN/NTN wireless communication configuration for the UE for the travel route based on the multi-network wireless coverage information; and
send, via the at least one transceiver, the joint TN/NTN wireless communication configuration to the UE.

14. The apparatus of claim 13, wherein the joint TN/NTN wireless communication configuration indicates a region, along the travel route, in which the UE is to refrain from use of a non-terrestrial network for wireless data communications.

15. The apparatus of claim 13, wherein the joint TN/NTN wireless communication configuration indicates that the UE is to use a first non-terrestrial network for wireless data communications in a first region along the travel route, and is to use a second non-terrestrial network for wireless data communications in a second region along the travel route.

16. The apparatus of claim 13, wherein the joint TN/NTN wireless communication configuration indicates a region, along the travel route, in which the UE is to perform wireless data communication in a dual-connectivity mode using both a terrestrial network and a non-terrestrial network.

17. The apparatus of claim 16, wherein the joint TN/NTN wireless communication configuration indicates a second region, along the travel route, in which the UE is to exit the dual-connectivity mode and perform wireless data communication using either the terrestrial network or the non-terrestrial network.

18. The apparatus of claim 13, wherein to determine the joint TN/NTN wireless communication configuration, the at least one processor is configured to determine the joint TN/NTN wireless communication configuration for the UE for the travel route based on the multi-network wireless coverage information and a time of day of the travel of the UE.

19. The apparatus of claim 18, wherein to determine the joint TN/NTN wireless communication configuration, the at least one processor is configured to identify, based on the NTN wireless coverage information and the time of day, a region along the travel route within which wireless coverage of a non-terrestrial network is diminished.

20. The apparatus of claim 19, wherein the joint TN/NTN wireless communication configuration indicates that the UE is to use an alternate non-terrestrial network for wireless data communication in the region along the travel route.

21. The apparatus of claim 19, wherein the joint TN/NTN wireless communication configuration indicates that the UE is to refrain from wireless data communication via non-terrestrial networks in the region along the travel route.

22. The apparatus of claim 13, wherein the at least one processor is further configured to select the travel route from among multiple candidate travel routes based on the multi-network wireless coverage information and a time of day of the travel of the UE.

23. The apparatus of claim 13, wherein to determine the joint TN/NTN wireless communication configuration, the at least one processor is configured to determine the joint TN/NTN wireless communication configuration for the UE for the travel route based on the TN wireless coverage information, the NTN wireless coverage information, and one or more quality of experience (QoE) criteria for the UE.

24. The apparatus of claim 13, wherein to send the joint TN/NTN wireless communication configuration to the UE, the at least one processor is configured to send, to the UE, configuration information that indicates the joint TN/NTN wireless communication configuration and the travel route.

25. A method for configuring multi-network wireless communication of a user equipment (UE), comprising:
sending position and destination information from the UE to a network node, the position and destination information indicating a start location of the UE and a destination location of the UE;
receiving, from the network node, configuration information indicating a joint terrestrial network (TN)/non-terrestrial network (NTN) wireless communication configuration for the UE for a travel route from the start location to the destination location; and
applying the joint TN/NTN wireless communication configuration at the UE during travel of the UE from the start location to the destination location via the travel route.

26. The method of claim 25, wherein the joint TN/NTN wireless communication configuration indicates a region, along the travel route, in which the UE is to refrain from use of a non-terrestrial network for wireless data communications.

27. The method of claim 25, wherein the joint TN/NTN wireless communication configuration indicates that the UE is to use a first non-terrestrial network for wireless data communications in a first region along the travel route, and is to use a second non-terrestrial network for wireless data communications in a second region along the travel route.

28. An apparatus for configuring multi-network wireless communication of a user equipment (UE), comprising:
at least one memory;
at least one transceiver; and
at least one processor coupled to the at least one memory and the at least one transceiver, the at least one processor configured to:
send, via the at least one transceiver, position and destination information from the UE to a network node, the position and destination information indicating a start location of the UE and a destination location of the UE;
receive, from the network node, via the at least one transceiver, configuration information indicating a joint terrestrial network (TN)/non-terrestrial network (NTN) wireless communication configuration for the UE for a travel route from the start location to the destination location; and
apply the joint TN/NTN wireless communication configuration at the UE during travel of the UE from the start location to the destination location via the travel route.

29. The apparatus of claim 28, wherein the joint TN/NTN wireless communication configuration indicates a region, along the travel route, in which the UE is to refrain from use of a non-terrestrial network for wireless data communications.

30. The apparatus of claim 28, wherein the joint TN/NTN wireless communication configuration indicates that the UE is to use a first non-terrestrial network for wireless data communications in a first region along the travel route, and is to use a second non-terrestrial network for wireless data communications in a second region along the travel route.
